(19) United States
(12) Patent Application Publication
(10) Pub. No.: US 2017/0309933 A1
(43) Pub. Date: Oct. 26, 2017

(54) SYSTEM AND METHOD FOR STARTING UP FUEL CELL SYSTEM

(71) Applicant: Hyundai Motor Company, Seoul (KR)

(72) Inventor: Ik Jae Son, Suwon (KR)

(21) Appl. No.: 15/353,652

(22) Filed: Nov. 16, 2016

(30) Foreign Application Priority Data
Apr. 26, 2016 (KR) 10-2016-0050878

(51) Int. Cl. H01M 8/04225; H01M 8/04302; H01M 8/0438

(52) U.S. Cl. CPC H01M 8/04225; H01M 8/04388; H01M 8/04302; H01M 2250/20

(57) ABSTRACT

A method for no-purge starting up a fuel cell system is provided. The method includes calculating a nitrogen partial pressure from a target hydrogen concentration during driving that corresponds to a condition in which start-up without purging is possible and calculating a target hydrogen pressure satisfying the target hydrogen concentration from the calculated nitrogen partial pressure. Further, hydrogen is then supplied to the system based on the target hydrogen pressure.

### CROSS-REFERENCE TO RELATED APPLICATION

This application is based on and claims the benefit of priority to Korean Patent Application No. 10-2016-0050878, filed on Apr. 26, 2016 in the Korean Intellectual Property Office, the disclosure of which is incorporated herein in its entirety by reference.

### TECHNICAL FIELD

The present disclosure relates to a system and method for starting up a fuel cell system, and more particularly, to a system and method for starting up a fuel cell system capable of improving a hydrogen utilization rate and minimizing loss of electric energy.

### BACKGROUND

Generally, a fuel cell system is a type of power generation system that generates electric energy by an electrochemical reaction between hydrogen and oxygen (oxygen in the air). For example, the fuel cell system is used in a fuel cell vehicle to operate an electric motor and drive the fuel cell vehicle. The fuel cell system may include a fuel cell stack that generates the electric energy, a fuel supplying device that supplies fuel (hydrogen) to the fuel cell stack, an air supplying device that supplies the oxygen in the air, which is an oxidizing agent required for the electrochemical reaction, to the fuel cell stack, and a heat and water managing device that removes reaction heat of the fuel cell stack to the outside of the fuel cell system and adjusts an operation temperature of the fuel cell stack.

The fuel cell generates electricity by the electrochemical reaction between the hydrogen, which is the fuel, and the air in the air, and discharges heat and water as reaction byproducts. In addition, the fuel cell stack used in the fuel cell vehicle includes a plurality of stacked unit cells, and a membrane-electrode assembly (MEA) is positioned at an innermost portion of each unit cell. The membrane-electrode assembly (MEA) includes an electrolyte membrane capable of moving protons, and an anode and a cathode each disposed on both surfaces of the electrolyte membrane to allow hydrogen and oxygen to react.

Meanwhile, in a start-up process of the fuel cell system used in the fuel cell vehicle, or the like, a nitrogen partial pressure of the anode based on a target hydrogen concentration during driving, whether additional purging is performed during the start-up, and a stop time is about 0 to 80 kPa. For example, when the target hydrogen concentration of an outlet during the driving is 60%, when a hydrogen concentration of the outlet increases to 100% by purging of hydrogen during shut-down of the fuel cell system, a nitrogen partial pressure may become 0 kPa. In addition, as a shut-down time of the fuel cell system (e.g., a parking time of the vehicle, or the like) is increased, air of the cathode and air diffused from the air into the cathode may be crossed over to the anode through the electrolyte membrane. Therefore, a concentration of gas such as the nitrogen, the oxygen, and the like, of the anode may increase.

In particular, the oxygen may be exhausted by reacting to residual hydrogen in the anode, and when the residual hydrogen is not present in the anode, an oxygen concentration may be gradually increased. In addition, the nitrogen, which is inert gas, does not react to the hydrogen, and a maximum nitrogen partial pressure becomes approximately 80 kPa when considering a nitrogen partial pressure in the air. When starting the fuel cell system after the shut-down of the fuel cell system as described above, residual oxygen may be consumed by additionally reacting to the hydrogen due to hydrogen supply of the anode to generate water, but the nitrogen, which is the inert gas, may be re-circulated together with the hydrogen, and residual nitrogen and the hydrogen may be simultaneously discharged during purging of the hydrogen to discharge the nitrogen in the start-up process.

Meanwhile, the purging of the hydrogen is not always required in the start-up of the fuel cell system, and it may be determined whether the purging of the hydrogen is performed in consideration of durability of the membrane-electrode assembly (MEA). For example, when the durability of the membrane-electrode assembly (MEA) of the fuel cell system is high, a target hydrogen concentration of the fuel cell system during driving may become relative low, and when the target hydrogen concentration of the fuel cell system is relatively low as described above, an amount of re-circulated hydrogen may become relatively high. In this condition, start-up without purging may be possible.

As described above, when the purging of the hydrogen for discharging the nitrogen is performed even in a condition in which the start-up without purging is possible, residual nitrogen and the hydrogen are discharged together thus causing a substantial reduction in a hydrogen utilization rate.

### SUMMARY

The present disclosure provides a system and method for starting up a fuel cell system capable of effectively implementing start-up of a fuel cell without purging by calculating a target hydrogen pressure that may satisfy a target hydrogen concentration of a condition in which the start-up of the fuel cell without purging is possible and/or a revolution per minute (RPM) of a hydrogen re-circulation blower.

According to an exemplary embodiment of the present disclosure, a method for starting a fuel cell system may include: calculating a nitrogen partial pressure of an anode; calculating a target hydrogen pressure satisfying a target hydrogen concentration from the calculated nitrogen partial pressure calculated; and supplying hydrogen based on the target hydrogen pressure.

In the nitrogen partial pressure calculation, the nitrogen partial pressure of the anode may be calculated from a target hydrogen concentration during driving that corresponds to a condition in which start-up without purging is possible. In addition, a target hydrogen concentration during driving that corresponds to a condition in which start-up without purging is possible may be selected from a gas partial pressure calculation model in which the nitrogen partial pressure of the anode is predicted based on the target hydrogen concentration, whether purging of the hydrogen is performed, and elapse of a shut-down time, and the nitrogen partial pressure may be calculated from the selected target hydrogen concentration. The method may further include, after the hydrogen supply, supplying air.

According to another exemplary embodiment of the present disclosure, a method for starting a fuel cell system may include: calculating a nitrogen partial pressure from a target hydrogen concentration during driving that corresponds to a condition in which start-up without purging is possible; calculating a target hydrogen pressure satisfying the target hydrogen concentration from the calculated nitrogen partial pressure; and calculating an RPM of a re-circulation blower satisfying a re-circulation rate of hydrogen that corresponds to the target hydrogen concentration; and supplying the hydrogen based on the target hydrogen pressure and re-circulating the hydrogen based on the RPM of the re-circulation blower.

In the nitrogen partial pressure calculation, the target hydrogen concentration during driving that corresponds to the condition in which the start-up without purging is possible may be selected from a gas partial pressure calculation model in which the nitrogen partial pressure of the anode is predicted based on the target hydrogen concentration, whether purging of the hydrogen is performed, and elapse of a shut-down time, and the nitrogen partial pressure may be calculated from the selected target hydrogen concentration. In the RPM calculation, a hydrogen stoichiometry may be selected based on the target hydrogen concentration, and the RPM of the re-circulation blower satisfying the selected hydrogen stoichiometry may be calculated. The method may further include, after the hydrogen supply and re-circulation, supplying air.

### BRIEF DESCRIPTION OF THE DRAWINGS

The above and other objects, features and advantages of the present disclosure will be more apparent from the following detailed description taken in conjunction with the accompanying drawings

FIG. 1 is a block diagram illustrating a fuel cell system according to various exemplary embodiments of the present disclosure;

FIG. 2 is a graph illustrating a gas partial pressure model of an anode in which a gas partial pressure of gas of the anode is predicted based on a target hydrogen concentration, whether purging of hydrogen is performed, and elapse of shut-down time of a fuel cell system according to an exemplary embodiment of the present disclosure;

FIG. 3 is a flow chart illustrating a method for starting a fuel cell system according to a first exemplary embodiment of the present disclosure;

FIG. 4 is a flow chart illustrating a method for starting a fuel cell system according to a second exemplary embodiment of the present disclosure;

FIG. 5 is a view illustrating a re-circulation blower performance map generated by measuring an amount of re-circulated hydrogen based on a pressure difference between an inlet and an outlet of a stack and representing performance of a re-circulation blower according to an exemplary embodiment of the present disclosure; and

FIG. 6 is a view illustrating an ejector performance map generated by measuring an amount of re-circulated hydrogen based on a pressure difference between an inlet and an outlet of a stack and representing performance of an ejector according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. For reference, sizes of components, thicknesses of lines, and the like, illustrated in the accompanying drawings referred to in describing the present disclosure may be exaggerated for convenience of the understanding. In addition, since terms used in a description of the present disclosure are defined in consideration of functions of the present disclosure, they may be changed depending on the intension of users or operators, customs, and the like. Therefore, these terms should be defined based on entire contents of the present disclosure.

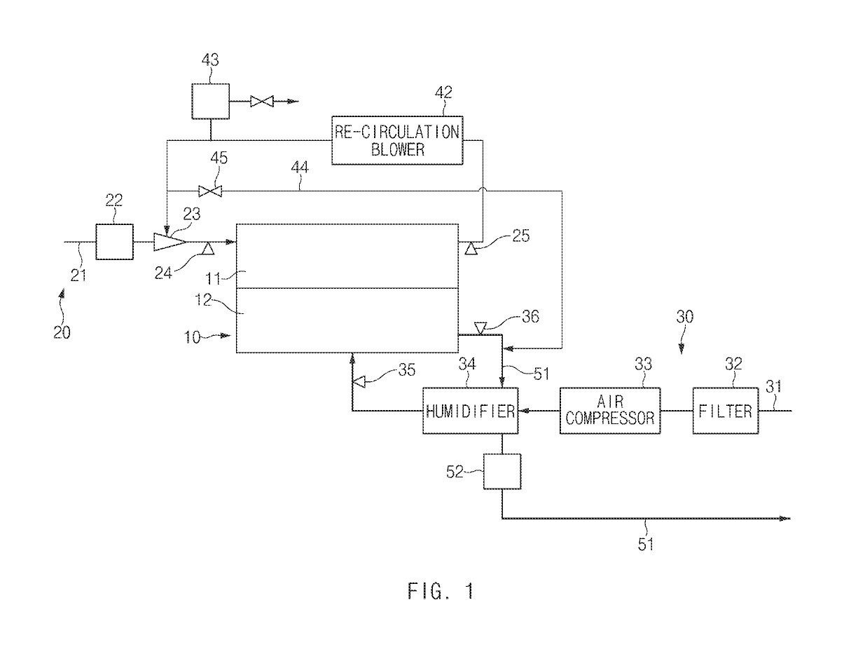

Referring to FIG. 1, a fuel cell system may include a stack 10 having an anode 11 and a cathode 12, a hydrogen supplying device 20 configured to supply hydrogen to the anode 11 of the stack 10, and an air supplying device 30 configured to supply air to the cathode 12 of the stack 10. The various components of the system may be operated by a controller.

The stack 10 may be an electricity generation assembly of unit fuel cells having the anode 11 and the cathode 12. The hydrogen supplying device 20 may have a hydrogen supplying line 21 connected from a hydrogen storing tank (not illustrated) to an inlet side of the anode 11, a hydrogen supplying valve (HSV) 22 installed on the hydrogen supplying line 21, an ejector 23 disposed between an inlet of the anode 11 and the hydrogen supplying valve 22, and the like. An inlet sensor 24 may be installed at the inlet side of the anode 11 and configured to measure a temperature, a pressure, and the like, of the inlet side of the anode 11, and an outlet sensor 25 may be installed at an outlet side of the anode 11 and configured to measure a temperature, a pressure, and the like, of the outlet side of the anode 11.

A re-circulation line 41 may be connected to an outlet of the anode 11, and may connect the outlet of the anode 11 and the ejector 23. A re-circulation blower 42 may be installed on the re-circulation line 41. In addition, a water trap 43 may be installed at a downstream side of the re-circulation blower 42 on the re-circulation line 41. The air supplying device 30 may have an air supplying line 31 connected to an inlet side of the cathode 12, a filter 32 installed at an upstream end of the air supplying line 31, an air compressor 33 installed at a downstream side of the filter 32, a humidifier 34 installed at a downstream side of the air compressor 33, and the like.

Further, an inlet sensor 35 may be installed at the inlet side of the cathode 12 and configured to measure a temperature, a pressure, and the like, of the inlet side of the cathode 12, and an outlet sensor 36 may be installed at an outlet side of the cathode 12 and configured to measure a temperature, a pressure, and the like, of the outlet side of the cathode 12. An air exhaust line 51 may be connected to an outlet of the cathode 12, and may pass through the humidifier 34 and be extended to the outside. In addition, a back pressure adjuster 52 may be installed at a downstream side of the air exhaust line 51. A purge line 44 may be branched from the re-circulation line 41 and may be connected to the air exhaust line 51 or the humidifier 34. A purge valve 45 may be installed on the purge line 44.

When the fuel cell system is intended to be started according to the present disclosure after a predetermined shut-down time of the fuel cell system elapses, a system controller may be configured to determine whether purging of hydrogen for the anode 11 is performed based on a target hydrogen concentration during driving of the vehicle. Particularly, the target hydrogen concentration may be variably selected based on durability of a membrane-electrode assembly of the stack 10, and the controller may be configured to determine whether the purging of the hydrogen is performed during start up the fuel cell system based on the target hydrogen concentration varied as described above. For example, when the target hydrogen concentration is less than a predetermined reference value may correspond to a condition in which start-up without purging that does not perform purging in a start-up process is possible. Further, when the target hydrogen concentration is greater than the predetermined reference value may correspond to a start-up condition with purging that should necessarily perform purging in the start-up process.

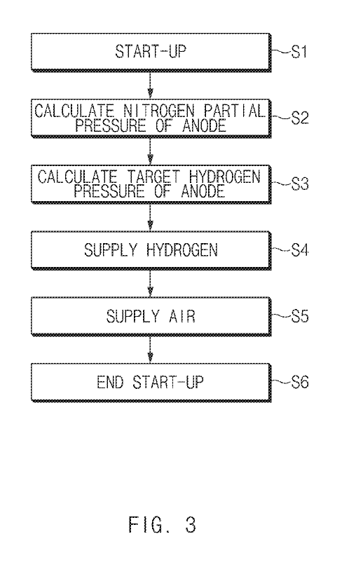

FIG. 3 is a flow chart illustrating a method for starting up a fuel cell system according to a first exemplary embodiment of the present disclosure. Referring to FIG. 3, after the fuel cell system is shut down for a predetermined period of time (e.g., a fuel cell vehicle is parked), when a controller of the fuel cell system receives a start-up signal (S1), a nitrogen partial pressure of the anode 11 of the stack 10 may be calculated through a gas partial pressure model (S2).

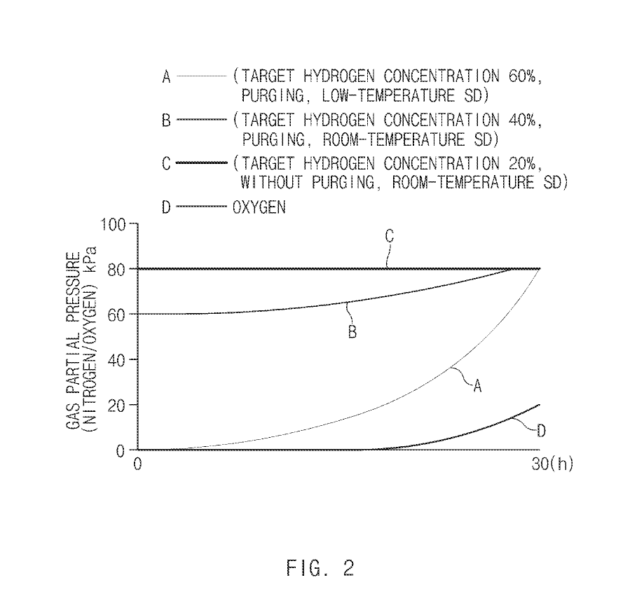

Particularly, a target hydrogen concentration during the driving that corresponds to the condition in which the start-up without purging is possible may be selected using a gas partial pressure model of the anode illustrated in FIG. 2, and the nitrogen partial pressure may be calculated from the target hydrogen concentration selected as described above. In FIG. 2, a gas partial pressure model of an anode in which a gas partial pressure of gas such as nitrogen, oxygen, or the like, present in the anode 11 is predicted based on a target hydrogen concentration, whether purging of hydrogen is performed, and elapse of shut-down time of a fuel cell system is illustrated.

The gas partial pressure model of FIG. 2 will be described in detail below. Line A of FIG. 2 illustrates that a nitrogen partial pressure is increased from about 0 kPa to 80 kPa based on elapse of shut-down time when a target hydrogen concentration of the outlet side of the anode 11 during the driving is about 60% and the fuel cell system is in a low-temperature shout-down (SD) state, and illustrates a start-up condition with purging in which the purging of the hydrogen is required.

Line B of FIG. 2 illustrates that a nitrogen partial pressure is increased from about 0 kPa to 80 kPa based on elapse of shut-down time when a target hydrogen concentration of the outlet side of the anode 11 during the driving is about 40% and the fuel cell system is in a room-temperature shout-down (SD) state, and illustrates a condition in which start-up without purging is possible. Line C of FIG. 2 illustrates that a nitrogen partial pressure is maintained substantially constant at about 80 kPa based on elapse of shut-down time when a target hydrogen concentration of the outlet side of the anode 11 during the driving is about 20% and the fuel cell system is in a room-temperature shout-down (SD) state, and illustrates a condition in which start-up without purging is possible. Line D of FIG. 2 illustrates that an oxygen partial pressure of the anode 11 during the driving is increased subtly.

The target hydrogen concentration during the driving corresponding to the condition in which the start-up without purging is possible (e.g., the condition corresponding to line B or line C of FIG. 2) may be selected, and the nitrogen partial pressure may be calculated from the target hydrogen concentration selected as described above. In other words, the nitrogen partial pressure may be calculated from the target hydrogen concentration that corresponds to the condition in which the start-up without purging is possible from the gas partial pressure model (S2).

A target hydrogen pressure satisfying the target hydrogen concentration selected in FIG. 2 may be calculated from the nitrogen partial pressure calculated as described above (S3). For example, when the target hydrogen concentration is about 40% and the fuel cell system is in the room-temperature shut-down state as illustrated in line B of FIG. 2, in a condition in which about 30 hours elapse as a shut-down time, the nitrogen partial pressure may be about 80 kPa. Therefore, when about 40% corresponding to the target hydrogen concentration, and about 80 kPa corresponding to the nitrogen partial pressure are substituted into Equation:

Target Hydrogen Concentration=((Target Hydrogen Pressure-Nitrogen Partial Pressure)/Target Hydrogen Pressure)×100,

40%=((Target Hydrogen Pressure−80)/Target Hydrogen Pressure)×100, and

the target hydrogen pressure of 133 kPa may be calculated from Equation:

40%=((Target Hydrogen Pressure−80)/Target Hydrogen Pressure)×100.

Therefore, the target hydrogen pressure that corresponds to the condition in which the start-up without purging is possible may be calculated, and the hydrogen supplying apparatus 20 of the fuel cell system may be appropriately operated based on the target hydrogen pressure calculated as described above to supply the hydrogen to the anode 11 (S4). Then, air may be supplied to the cathode 12 (S5). In particular, a coolant may also be supplied into the stack 10 to prevent the stack 10 from being overheated. Further, when power for driving the vehicle is generated by a reaction between the anode 11 and the cathode 12 of the stack 10, a start-up process may end (S6). After the start-up is complete, the supply of the hydrogen may be variously adjusted based on a driving situation, a condition, or the like to thus drive the vehicle. In addition, the supply of the air and the supply of the coolant may be appropriately adjusted.

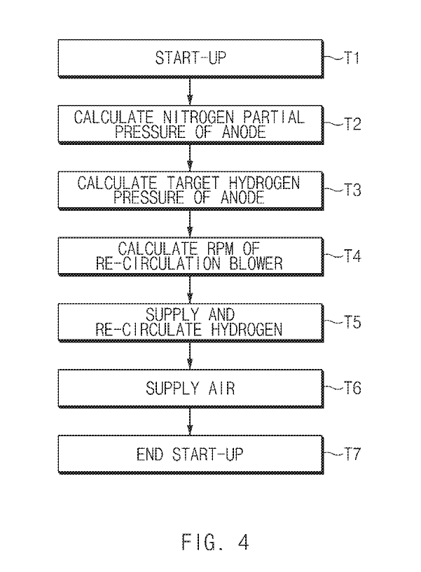

FIG. 4 is a flow chart illustrating a method for starting up a fuel cell system according to a second exemplary embodiment of the present disclosure. Referring to FIG. 4, after the fuel cell system is shut down for a predetermined period of time (e.g., when a fuel cell vehicle is parked), when a start-up signal is generated in the fuel cell system (T1), a nitrogen partial pressure of the anode 11 of the stack 10 is calculated using a gas partial pressure model (T2).

In the calculation of the nitrogen partial pressure, as described above, a target hydrogen concentration during the driving of the vehicle that corresponds to the condition in which the start-up without purging is possible may be selected using the gas partial pressure model of the anode illustrated in FIG. 2, and the nitrogen partial pressure may be calculated from the target hydrogen concentration during the driving of the vehicle selected as described above (T2). A target hydrogen pressure satisfying the target hydrogen concentration may be calculated from the nitrogen partial pressure calculated as described above (T3). In other words, the target hydrogen pressure that corresponds to the condition in which the start-up without purging is possible may be calculated.

Further, a revolution per minute (RPM) of a re-circulation blower 42 may be calculated to satisfy a re-circulation rate of the hydrogen that corresponds to the target hydrogen concentration corresponding to the condition in which the start-up without purging is possible (T4). Particularly, the re-circulation rate of the hydrogen may be calculated from the target hydrogen concentration using a predetermined map.

According to an exemplary embodiment, a hydrogen stoichiometry (SR) that corresponds to the target hydrogen concentration (or a re-circulation rate of the hydrogen) that corresponds to the condition in which the start-up without purging is possible may be selected, and the RPM of the re-circulation blower satisfying the hydrogen stoichiometry (SR) selected as described above may be calculated. The following Table 1 is a table in which RPM conditions of the re-circulation blower 42 used to calculate the RPM of the re-circulation blower 42 satisfying the target hydrogen concentration are mapped, but the present disclosure is not limited thereto, and may be variously modified based on conditions, specifications, and the like.

TABLE 1

| Target Hydrogen Concentration (%) | RPM of Re-circulation Blower |
|---|---|
| 20% | 12000 RPM |
| 40% | 9000 RPM |
| 60% | 6000 RPM |

In the above Table 1, the RPM conditions of the re-circulation blower 42 in a reference condition of a re-circulation mass of the hydrogen in which the hydrogen stoichiometry (SR) is 1.5, a relative humidity (RA) is 100% (measured by a temperature sensor), the fuel cell system may be operated at a normal pressure (100 kPa), and a minimum flow rate supplying reference current is 40 A are mapped. For example, Table 1 shows that the RPM of the re-circulation blower 42 for satisfying the hydrogen stoichiometry (SR) of 1.5 is 12000 RPM when the target hydrogen concentration is 20% and is 9000 RPM when the target hydrogen concentration is 40%.

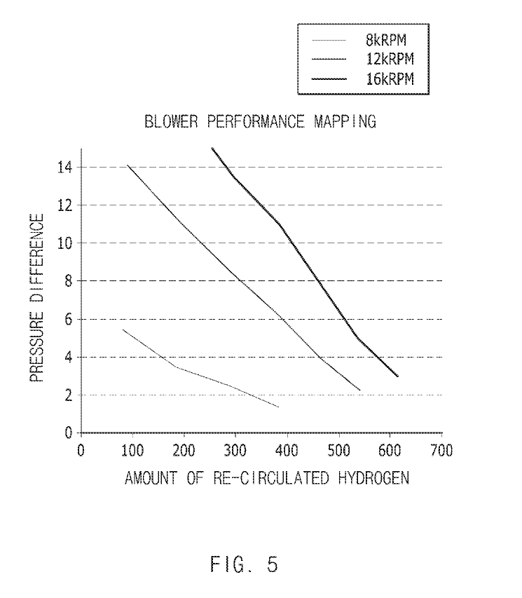

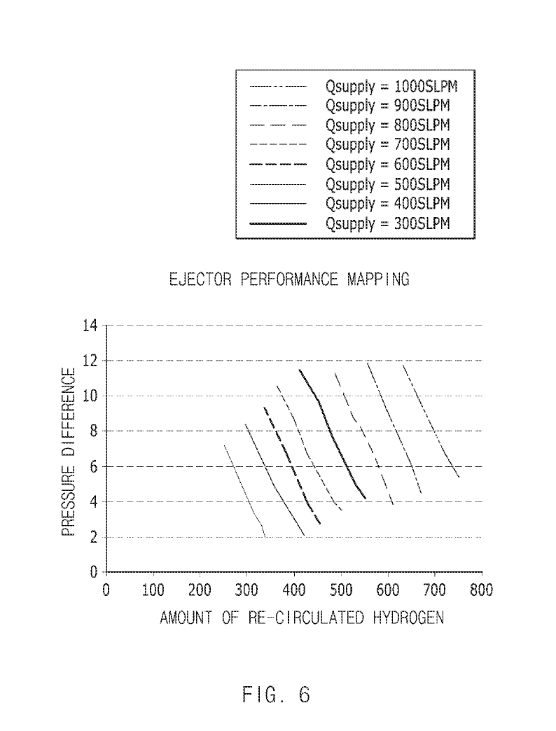

Additionally, Table 1 shows that as the target hydrogen concentration increases, the nitrogen concentration decreases, and thus, the re-circulation mass of the hydrogen may decrease (since a density of the nitrogen is greater than that of the hydrogen), and the RPM of the re-circulation blower 42 may thus decrease. In addition, according to the above Table 1, the RPM conditions of the re-circulation blower 42 for satisfying the hydrogen stoichiometry (SR) may rely on performance of the re-circulation blower 42 and performance of the ejector 23. Therefore, mapping for the RPMs of the re-circulation blower 42 in which a hydrogen re-circulation flow rate calculated through a re-circulation blower performance map (illustrated in FIG. 5) and an ejector performance map (illustrated in FIG. 6) is reflected may be demanded.

FIG. 5 is a view illustrating a re-circulation blower performance map created by measuring an amount of re-circulated hydrogen based on a pressure difference between an inlet and an outlet of a stack 10 and representing performance of a re-circulation blower 42, and the present disclosure is not limited to FIG. 5, but may be variously modified. In addition, the re-circulation blower performance map may also be mapped based on temperatures of the inlet/outlet of the stack 10, a gas composition, (e.g., a component ratio of hydrogen, nitrogen, and vapor) and the like.

FIG. 6 is a view illustrating an ejector performance map generated by measuring an amount of re-circulated hydrogen based on a pressure difference between an inlet and an outlet of a stack 10 and representing performance of an ejector 23, but the present disclosure is not limited to FIG. 6, and may be variously modified based on conditions, specifications, and the like. In addition, the ejector performance map may also be mapped based on temperatures of the inlet/outlet of the stack 10, a gas composition, (e.g., a component ratio of hydrogen, nitrogen, and vapor) and the like.

Furthermore, the hydrogen supplying device 20 of the fuel cell system may be operated based on the target hydrogen pressure that corresponds to the condition in which the start-up without purging is possible to supply the hydrogen to the anode 11, and the re-circulation blower 42 may be operated based on the RPM of the re-circulation blower 42 calculated based on the target hydrogen pressure to re-circulate the hydrogen from the outlet of the anode 11 to the inlet of the anode 11 (T5). Then, air may be supplied to the cathode 12 (T6). In particular, a coolant may also be supplied into the stack 10 to prevent the stack 10 from being overheated.

When power for driving is generated by a reaction between the anode 11 and the cathode 12 of the stack 10, a start-up process may be terminated (e.g., complete) (T7). In the driving of the vehicle after the start-up is complete, the supply of the hydrogen, the re-circulation rate of the hydrogen, and the like, may be variously adjusted based on a driving situation, a condition, or the like. In addition, the supply of the air and the supply of the coolant may be adjusted accordingly.

As described above, according to the exemplary embodiment of the present disclosure, the nitrogen partial pressure may be calculated from the target hydrogen concentration that corresponds to the condition in which the start-up without purging is possible from a gas partial pressure prediction model of the anode, the target hydrogen pressure that corresponds to the condition in which the start-up without purging is possible and/or the RPM of the re-circulation blower may be calculated using the nitrogen partial pressure calculated as described above, and the hydrogen supplying device and the re-circulation blower may be operated based on the target hydrogen pressure and the RPM of the re-circulation blower, and thus, the start-up without purging in the condition in which the start-up without purging is possible may be efficiently implemented, thereby making it possible to improve a hydrogen utilization rate and minimize loss of electric energy.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for no-purge starting of a fuel cell system, comprising:
calculating, by a controller, a nitrogen partial pressure of an anode;
calculating, by the controller, a target hydrogen pressure satisfying a target hydrogen concentration from the calculated nitrogen partial pressure; and
supplying, by the controller, hydrogen to the fuel cell system based on the target hydrogen pressure.

2. The method according to claim 1, wherein in the nitrogen partial pressure calculation, the nitrogen partial pressure of the anode is calculated from a target hydrogen concentration during driving of a vehicle to a condition in which start-up without purging is possible.

3. The method according to claim 1, wherein in the nitrogen partial pressure calculation, a target hydrogen concentration during driving of a vehicle corresponding to a condition in which start-up without purging is possible is selected from a gas partial pressure calculation model in which the nitrogen partial pressure of the anode is predicted based on the target hydrogen concentration, whether purging of the hydrogen is performed, and elapse of a shut-down time, and the nitrogen partial pressure is calculated from the selected target hydrogen concentration.

4. The method according to claim 1, further comprising:
supplying air to the fuel cell system after the hydrogen supply.

5. A method for no-purge starting up a fuel cell system, comprising:
calculating, by a controller, a nitrogen partial pressure from a target hydrogen concentration during driving that corresponds to a condition in which start-up without purging is possible;
calculating, by the controller, a target hydrogen pressure satisfying the target hydrogen concentration from the calculated nitrogen partial pressure; and
calculating, by the controller, a revolutions per minute (RPM) of a re-circulation blower satisfying a re-circulation rate of hydrogen that corresponds to the target hydrogen concentration; and
supplying, by the controller, the hydrogen to the fuel cell system based on the target hydrogen pressure and re-circulating the hydrogen based on the RPM of the re-circulation blower.

6. The method according to claim 5, wherein in the nitrogen partial pressure calculation, the target hydrogen concentration during driving that corresponds to the condition in which the start-up without purging is possible is selected from a gas partial pressure calculation model in which the nitrogen partial pressure of the anode is predicted based on the target hydrogen concentration, whether purging of the hydrogen is performed, and elapse of a shut-down time, and the nitrogen partial pressure is calculated from the selected target hydrogen concentration.

7. The method according to claim 5, wherein in the RPM calculation, a hydrogen stoichiometry is selected based on the target hydrogen concentration, and the RPM of the re-circulation blower satisfying the selected hydrogen stoichiometry is calculated.

8. The method according to claim 5, further comprising;
supply, by the controller, air to the fuel cell system after the hydrogen supply.

9. A system for non-purge starting of a fuel cell system, comprising:
a fuel cell stack having an anode and a cathode;
a hydrogen supply device configured to supply hydrogen to the anode;
an air supply device configured to supply air to the cathode; and
a controller configured to:
calculate a nitrogen partial pressure of the anode;
calculate a target hydrogen pressure satisfying a target hydrogen concentration from the calculated nitrogen partial pressure; and
operate the hydrogen supply device to supply hydrogen to the fuel cell system based on the target hydrogen pressure.

10. The system of claim 9, wherein the nitrogen partial pressure of the anode is calculated from a target hydrogen concentration during driving of a vehicle to a condition in which start-up without purging is possible.
